(19) United States
(12) Patent Application Publication
(10) Pub. No.: US 2026/0222740 A1
(43) Pub. Date: Jul. 30, 2026

(54) METHOD FOR VOICE SIGNAL SWITCHING AND RELATED PRODUCTS

(71) Applicant: Nothing Technology Limited, London (GB)

(72) Inventor: Weisheng Xu, Shenzhen (CN)

(21) Appl. No.: 19/452,082

(22) Filed: Jan. 16, 2026

(30) Foreign Application Priority Data
Jan. 24, 2025 (CN) 202510123274.8

(51) Int. Cl. H04R 5/04; H04R 1/02

(52) U.S. Cl. CPC H04R 5/04; H04R 1/02; H04R 2420/07

(57) ABSTRACT

In a method for voice signal switching, a first sound pickup device with a first microphone and a second sound pickup device with a second microphone are included. The first sound pickup device is used for connecting with a first terminal device. The first microphone is used for collecting a sound signal and transmitting the sound signal to the first terminal device. The method further includes the following. Information of a connection state of the second sound pickup device is received. When the connection state is that the second sound pickup device is connected to the first sound pickup device, or the connection state is that the second sound pickup device is connected to the first terminal device, a voice signal switching instruction is received, and collection of the sound signal is controlled to switch between the first microphone and the second microphone.

### TECHNICAL FIELD

This disclosure relates to the field of communication, and more particularly, to a method for voice signal switching and related products.

### BACKGROUND

A wearable device typically includes a device body and a device storage unit. The device body is for wearing and serves as a functional core of the wearable device, and the device storage unit is used for storing, protecting, and charging the device body. When a wearable device communicates with a terminal device, the device body is generally connected to the terminal device, while the device storage unit is in an idle state. In many scenarios, when a user wears the device body, the user needs to transmit a voice signal to the terminal device through the device body. However, in a noisy environment, in addition to the sound signal of the user, the microphone of the device body also picks up a large amount of ambient noise, which adversely affects the quality of the voice signal.

As a result, in the noisy environment, it is difficult for the device body to accurately extract the sound signal of the user, resulting in the wearable device being unable to provide a satisfactory voice function. In view of this, there is an urgent need to provide a voice signal switching solution to improve the voice input effect of the wearable device in the noisy environment.

### SUMMARY

In order to solve at least one or more of the technical issues described in the background section above, the present disclosure provides the following technical solution and multiple embodiments thereof.

In a first aspect, the present disclosure discloses a method for voice signal switching. The method includes a first sound-pickup device with a first microphone and a second sound-pickup device with a second microphone. The first sound-pickup device is used for connecting with a first terminal device. The first microphone is used for collecting a target sound signal and transmitting the sound signal to the first terminal device. The method further includes the following. Information of a connection state of the second sound-pickup device is received. When the connection state is that the second sound-pickup device is connected to the first sound-pickup device, or that the second sound-pickup device is connected to the first terminal device, a voice signal switch instruction is received, and collection of the target sound signal is controlled to switch from the first microphone to the second microphone.

In a second aspect, the present disclosure discloses a voice signal switching system. The system includes a first sound-pickup device with a first microphone and a second sound-pickup device with a second microphone. The first sound-pickup device is configured to connect with a first terminal device. The first microphone is configured to collect a sound signal and transmit the sound signal to the first terminal device. The system is configured to receive information of a connection state of the second sound-pickup device. When the connection state is that the second sound-pickup device is connected to the first sound-pickup device, or that the second sound-pickup device is connected to the first terminal device, the system controls collection of sound signal to switch between the first microphone and the second microphone based on the voice signal switch instruction.

In a third aspect, the present disclosure discloses a wearable device. The wearable device includes a first microphone. The wearable device is configured to connect with a first terminal device. The first microphone is configured to collect a sound signal and transmit the sound signal to the first terminal device. The wearable device is further configured to stop using the first microphone to collect the sound signal or stop using the first microphone to transmit the sound signal to the first terminal device in response to receiving the first voice signal switch instruction, or use the first microphone to collect the sound signal and transmit the sound signal to the first terminal device in response to receiving the second voice signal switch instruction.

In a fourth aspect, the present disclosure discloses a sound-pickup device. The sound-pickup device includes a second microphone. The sound-pickup device is configured to connect with a communication device. The second microphone is configured to collect a sound signal and transmit the sound signal to the communication device. The sound-pickup device is further configured to use the second microphone to collect the sound signal and transmit the sound signal to the communication device in response to receiving a first voice signal switch instruction. Alternatively, the sound-pickup device is further configured to stop using the second microphone to collect the sound signal and to transmit the sound signal to the communication device in response to receiving a second voice signal switch instruction.

According to the voice signal switching solution disclosed in the present disclosure, a first sound-pickup device and a second sound-pickup device can collect sound signals and send a voice signal obtained from the sound signals to the terminal device.

Accordingly, the first sound-pickup device or the second sound-pickup device may be selected flexibly for voice input, thus improving the voice input effect in a noisy environment. Furthermore, the method for voice signal switching disclosed in the present disclosure allows a user to actively switch microphones as needed, or enables the first sound-pickup device, the second sound-pickup device, or the terminal device to capture the intention of the user to automatically switch microphones, thereby maintaining the voice input performance in a convenient and intelligent way.

### BRIEF DESCRIPTION OF THE DRAWINGS

With reference to the detailed description below, the above and other objectives, features, and advantages of the exemplary embodiments of the present disclosure will be easy to understand. In the drawings, several embodiments of the present disclosure are illustrated in a way of explanation rather than limitation, and the same or corresponding reference signs indicate the same or corresponding parts.

FIG. 1 is an exemplary schematic diagram of a wireless earphone in some embodiments of the present disclosure.

FIG. 2 is an exemplary schematic diagram illustrating communication between a wearable device and a terminal device in some embodiments of the present disclosure.

FIG. 3 is an exemplary schematic diagram illustrating voice transmission using a wearable device in some embodiments of the present disclosure.

FIG. 4 is an exemplary schematic diagram of a method for voice signal switching in some embodiments of the present disclosure.

FIG. 5 is an exemplary schematic diagram of a physical button in some embodiments of the present disclosure.

FIG. 6 is an exemplary schematic diagram illustrating the positional relationship between an earphone body and an earphone storage case in some embodiments of the present disclosure.

FIG. 7 is an exemplary schematic diagram illustrating a working principle of a position sensor in some embodiments of the present disclosure.

FIG. 8 is an exemplary schematic diagram illustrating a working mode in some embodiments of the present disclosure.

Description of reference signs: 100–an earphone storage case; 10–a shell; 11–a mounting slot; 20–a button.

### DETAILED DESCRIPTION

The following will clearly and completely describe the technical solution of embodiments of the disclosure with reference to the accompanying drawings in embodiments of the disclosure. Obviously, the described embodiments are part of the embodiments of the present disclosure, not all of the embodiments. Based on the embodiments in the present disclosure, any other embodiments obtained by those skilled in the art without making creative efforts shall belong to the protection scope of the present disclosure.

It should be understood that terms “include” and “comprise” used in the specification and claims of the present disclosure indicate the presence of the described features, integers, steps, operations, elements and/or components, but do not exclude the presence or addition of one or more other features, integers, steps, operations, elements, components and/or sets thereof.

It should also be understood that the terms used in the specification of the present disclosure are only for the purpose of describing specific embodiments and are not intended to limit the present disclosure. As used in the specification and claims of the present disclosure, singular forms “a”, “an” and “the” are intended to include plural forms unless the context clearly indicates otherwise. It should be further understood that the term “and/or” used in the specification and claims of the present disclosure refers to any combination and all possible combinations of one or more of the associated listed items, and includes these combinations.

As used in the specification and claims, the term “if” may be interpreted in the context as “when”, “once”, “in response to determining” or “in response to detecting”. Similarly, the phrase “if it is determined” or “if [the described condition or event] is detected” may be interpreted according to the context as meaning “once it is determined”, “in response to determining”, “once [the described condition or event] is detected”, or “in response to detecting [the described condition or event]”.

The specific implementations of the present disclosure will be described in detail below with reference to the accompanying drawings. To clearly explain the technical solution disclosed in the present disclosure, relevant hardware implementations and related technical terms in the embodiments of the present disclosure are first introduced below.

A wearable device refers to a portable electronic device that can be directly worn on the body or integrated into clothing or accessory of a user. Common wearable devices include smartwatches, smart glasses, smart bands, smart rings, wireless earphones, etc., where wireless earphones further include true wireless stereo (TWS), open wireless stereo (OWS), headsets, etc.

Generally, a wearable device includes a device body and a device storage unit. The device body is for wearing and serves as a functional core of the wearable device, and the device storage unit is used for protecting and charging the device body. FIG. 1 is an exemplary schematic diagram of a wireless earphone in some embodiments of the present disclosure. As illustrated in FIG. 1, the wireless earphone includes a left (L) earphone body, a right (R) earphone body, and an earphone storage case. By removing the earphone body from the storage case, the earphone body can be connected to another communication device, thereby making the earphone body into a working state. By placing the earphone body back into the storage case, the earphone body can enter a charging state, that is, the storage case is used for charging the earphone body. Other wearable devices, for example, a smartwatch includes a watch body and a watch case as a storage unit, and smart glasses have a glasses body and a glasses case as a storage unit.

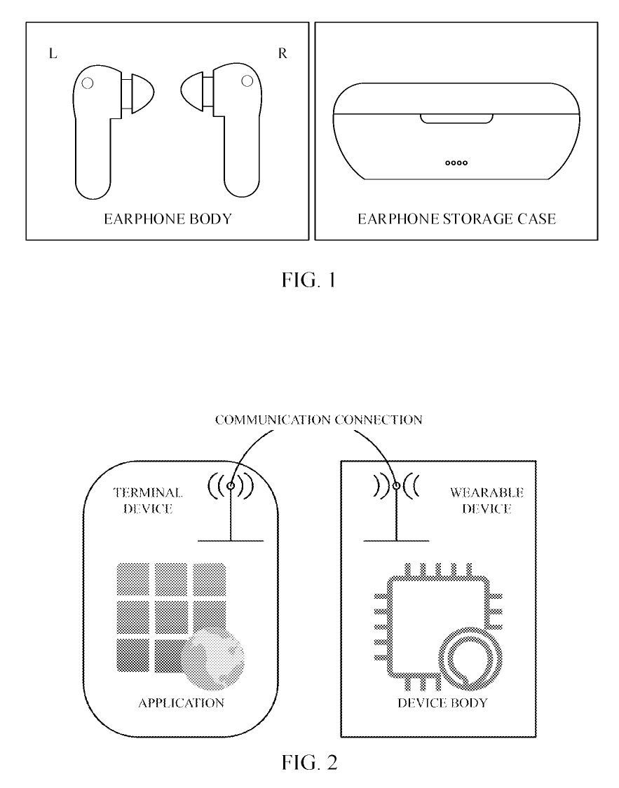

FIG. 2 is an exemplary schematic diagram illustrating communication between a wearable device and a terminal device in some embodiments of the present disclosure. The device body of the wearable device typically includes a built-in communication connection technology, which enables communication connection and data exchange between the device body and the terminal device. The communication connection technology includes Bluetooth connection, Wi-Fi connection, cellular network connection, etc. The most common working state of the wearable device is connecting the device body to the terminal device using the built-in communication connection technology. The terminal device can be a mobile phone or a laptop, which generally has a powerful computing capability to run complex applications. For example, when a wireless earphone is connected to the mobile phone, the wireless earphone can be used for playing songs from a music software on the mobile phone. When a smartwatch is connected to the mobile phone, human vital sign data monitored by the smartwatch can be transmitted to a medical software running on the mobile phone for analysis. It is worth noting that since the storage unit of the wearable device generally only serves to store the device body, protect the device body, and charge the device body, when the device body is in communication connection with the terminal device and in the working state, the storage unit is usually in an idle state.

In many scenarios, when people wear the device body, the people need to transmit a voice signal to the terminal device through the wearable device. For example, when the wireless earphone is connected to the mobile phone, the earphone can be used for a voice call or sending a voice message. When the smartwatch is connected to the mobile phone, a function of a sport software on the mobile phone can be set by voice. For example, a voice command “Start a 5-kilometer running exercise, with the starting point at the south gate of the park and the ending point at the north gate of the park. Please start planning the exercise route and record the pace and heart rate during the run” can be input to plan and record the exercise process using the sport software. When a pair of smart glasses is connected to the laptop, a function of video software on the laptop can be set by voice. For example, a voice command “Please play the highest-grossing movie in the 2024 Lunar New Year film season” can be input to watch a movie. With the development of large language models (LLM) technology, many applications that use LLM for conducting voice conversations with users have emerged in the market. When the wireless earphone is connected to the mobile phone, users can conduct a real-time voice conversation with the LLM through the earphone body, leveraging the generative ability of the LLM to provide professional answers.

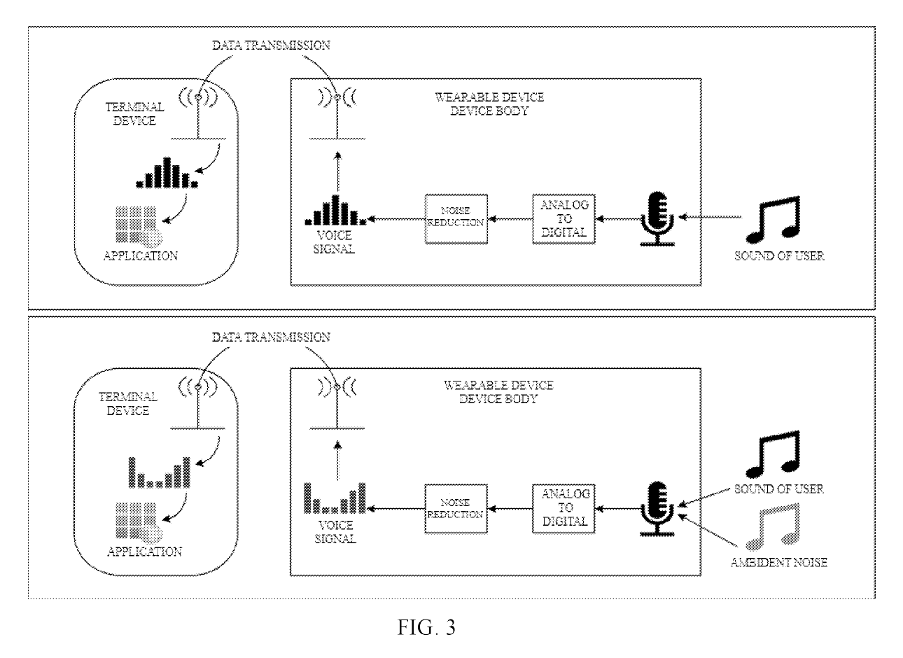

FIG. 3 is an exemplary schematic diagram illustrating voice transmission using a wearable device in some embodiments of the present disclosure. As illustrated in the upper part of FIG. 3, a device body of the wearable device is provided with a microphone for collecting sound of a user. The sound of the user is input into the microphone in a form of analog signal, which is converted into a digital signal after analog-to-digital (A/D) conversion. A general device body is provided with a noise reduction model for separating the sound of the user from ambient noise and improving the quality of the digital signal, thereby obtaining a noise-reduced voice signal. Subsequently, the device body sends the voice signal. After the terminal device receives the voice signal, the voice signal is used as input for the corresponding application, thereby software functions of the terminal device are used for processing the voice signal. However, in a noisy environment, in addition to the sound of the user, the microphone of the device body also picks up a large amount of ambient noise. As illustrated in the lower part of FIG. 3, the sound of the user picked up by the microphone at the device side is mixed with relatively more ambient noise, resulting in poor quality of the obtained voice signal. The poor quality of the voice signal means that the voice signal cannot effectively represent the sound of the user. Specifically, the intensity of a signal component corresponding to the sound of the user in the voice signal is much smaller than the intensity of a signal component corresponding to the ambient noise, and after converting the voice signal into the analog signal, the sound of the user cannot be clearly distinguished. In this case, inputting the voice signal with poor quality into the application on the terminal device may cause a program running result not conforming to the intended use of the user. Exemplarily, when the user makes a voice call using the wireless earphone, if the microphone of the earphone body cannot pick up the sound of the user at a short distance, the microphone may pick up a large amount of ambient noise during the call in the noisy environment, which causes the other party of the call to be unable to hear the sound of the user clearly, thereby resulting in the low call quality. For example, for a machine voice scenario, when the user conducts a voice conversation with the LLM through the device body of the wearable device, since the LLM recognizes voiceprint information, the quality of content generated by the LLM is directly affected by the quality of the voice signal input by the user, so that the performance of the LLM depends on the accuracy of the voice signal of the user. If the voice signal contains a lot of noise, it will cause the LLM to generate an incorrect answer. Alternatively, in the noisy environment, if a lot of ambient noise is still picked up after the user finishes speaking, the LLM may be misled by the invalid voice signal to generate an incorrect answer, thereby reducing the user experience of conducting the voice conversation with the LLM.

To improve the sound pickup effect of the wearable device in the noisy environment, the present disclosure discloses a method for voice signal switching. The method includes a first sound-pickup device with a first microphone and a second sound-pickup device with a second microphone. The first sound-pickup device is used for connecting with a first terminal device. The first microphone is used for collecting a target sound signal and transmitting the sound signal to the first terminal device. The method further includes the following. A connection state of the second sound-pickup device is received. When the connection state is that the second sound-pickup device is connected to the first sound-pickup device, or that the second sound-pickup device is connected to the first terminal device, a voice signal switch instruction is received, and collection of the target sound signal is controlled to switch from the first microphone to the second microphone.

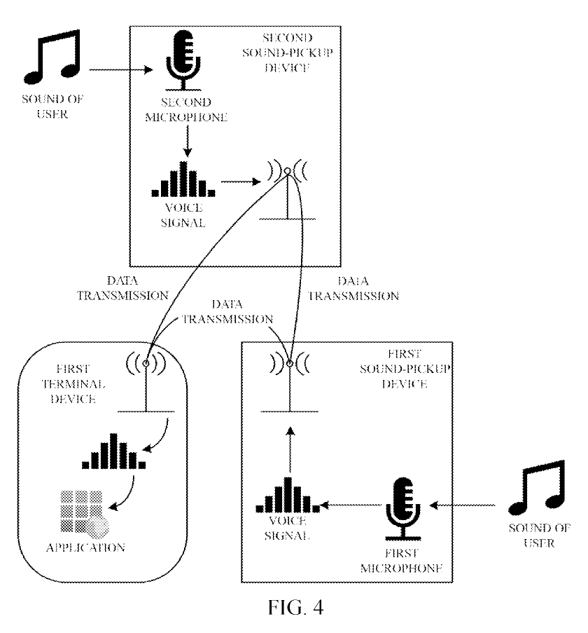

FIG. 4 is an exemplary schematic diagram of a method for voice signal switching in some embodiments of the present disclosure. As illustrated in FIG. 4, both a first microphone in a first sound-pickup device and a second microphone in a second sound-pickup device can be used for collecting a sound signal of a user. A communication connection can be established between any two of the first sound-pickup device, the second sound-pickup device, and a first terminal device. Thus, the first sound-pickup device can transmit a voice signal generated by the first microphone to the terminal device through a communication connection between the first sound-pickup device and the terminal device. The second sound-pickup device can transmit a voice signal generated by the second microphone to the terminal device through a communication connection between the second sound-pickup device and the terminal device. In addition, the second sound-pickup device can transmit the voice signal generated by the second microphone to the first sound-pickup device through the communication connection between the first sound-pickup device and the second sound-pickup device, and then the first sound-pickup device transmits the voice signal to the terminal device through the communication connection between the first sound-pickup device and the terminal device. Therefore, both the first sound-pickup device and the second sound-pickup device can be used for collecting the sound signal and sending the voice signal converted from the sound signal to the first terminal device. Thus, switching can be performed between the first sound-pickup device and the second sound-pickup device for selecting either the first sound-pickup device or the second sound-pickup device to collect the sound signal as needed, thereby ensuring that the voice signal of high quality can be stably obtained by the first terminal device.

It should be understood that when the user uses the sound-pickup device for voice input in an environment containing noise, the target sound signal picked up by the microphone is the sound signal of the user, and the target sound signal does not contain or only contains a small amount of ambient noise.

It should be understood that the connection state of the second sound-pickup device includes the following. The second sound-pickup device is not connected to any device, or is selectively connected to the first sound-pickup device or the first terminal device. In some embodiments, switching to use the first microphone or the second microphone to collect the sound signal can be performed according to the connection state of the second sound-pickup device. In the embodiments, the first sound-pickup device is connected with the first terminal device and the first microphone is used for collecting the sound signal. In this case, the switching includes the following. The second microphone is enabled to collect the sound signal and the first microphone is stopped collecting the sound signal. Alternatively, after comparing the voice signals obtained by the first microphone and the second microphone, either the first microphone or the second microphone is selected to collect the sound signal.

In some embodiments, the voice switch signal is used for controlling the collection of the target sound signal to switch between the first microphone and the second microphone. It should be understood that depending on different initial states, the so-called “switching” includes different execution actions. In some embodiments, in an initial state where no microphone is being used for collecting the sound signal, the connection state of the first sound-pickup device and/or the second sound-pickup device can be obtained. When the first sound-pickup device and/or the second sound-pickup device is connected to the first terminal device, the switching includes that the first microphone or the second microphone is selected to collect the sound signal. In an initial state where the second microphone is being used for collecting the sound signal, the connection state of the first sound-pickup device can be obtained. When the first sound-pickup device is connected to the first terminal device, the switching includes the following execution actions. The first microphone is enabled to collect the sound signal and the second microphone is stopped collecting the sound signal. Alternatively, after comparing the voice signals obtained by the first microphone and the second microphone, the first microphone or the second microphone is selected to collect the sound signal.

In some embodiments, the first sound-pickup device is an earphone body of a wireless earphone, the second sound-pickup device is an earphone storage case corresponding to the wireless earphone, and the first terminal device is a mobile phone. In the embodiments, for a voice call scenario, the user can choose to connect the earphone body to the mobile phone to make a voice call with the other party of the communication through the earphone body. In this case, the earphone body can transmit the sound of the other party to the user's ear, and additionally transmit the sound of the user. It should be understood that when using the earphone body for a voice call, the user needs to wear the earphone body on the ears, so the microphone of the earphone body is far from the user's mouth, which causes the other party to be unable to hear the sound of the user clearly in a noisy environment. In this case, the user can pick up the earphone storage case and place the earphone case close to the user's mouth, and the microphone of the earphone storage case can collect the sound of the user at a short distance, which achieves a clear call in the noisy environment. In addition, using the earphone storage case for sound pickup at a short distance in a public place allows the user to be heard clearly by the other party without speaking loudly, thereby effectively protecting call privacy.

In some embodiments, the user of the first sound-pickup device and the second sound-pickup device is user A, and the user of the first terminal device is user B. User A can conduct a voice conversation with user B through the first sound-pickup device and the second sound-pickup device respectively.

It should be understood that the present disclosure enables the storage unit to have the sound pickup function and the communication function by adding a microphone and a communication unit to the storage unit of the wearable device, so that the storage unit or the device body can be flexibly selected for voice input, which improves the voice input effect of the wearable device in the noisy environment.

In some embodiments, at least one of the first sound-pickup device, the first terminal device, or the second sound-pickup device is provided with a button. The method for voice signal switching includes the following. When the button triggers the voice signal switch instruction, the collection of the sound signal is controlled to switch between the first microphone and the second microphone.

In some embodiments, the button is a physical button, similar to a volume button or a power button set on a mobile phone. In the embodiments, a pressable physical button is provided on the first sound-pickup device, the first terminal device, or the second sound-pickup device. When the button is pressed, the voice signal switch instruction is generated. The voice signal switch instruction is transmitted to a controller of the device (the device where the button is on) through a signal line, and the controller performs the microphone switching action after receiving the voice signal switch instruction.

In some other embodiments, the button is a virtual button, such as a button for the user to click or a slidable slider provided on a user interface of an application software. In the embodiments, the virtual button is provided on the first sound-pickup device, the first terminal device, or the second sound-pickup device. When the button is operated, the voice signal switch instruction can be generated. The voice signal switch instruction is captured by the controller of the device (the device where the button is on), and the controller performs the microphone switching after receiving the voice signal switch instruction.

It should be understood that by providing the button on the first sound-pickup device, the first terminal device, or the second sound-pickup device, the embodiments of the present disclosure allow the user to actively switch the first microphone or the second microphone to collect the voice signal. The user can select the microphone as needed to maintain the voice input effect, and the action required for switching is convenient for the user.

In some embodiments, the first sound-pickup device is the earphone, the second sound-pickup device is the earphone storage case corresponding to the earphone, and the button is provided on the earphone storage case.

FIG. 5 is an exemplary schematic diagram of a physical button in some embodiments of the present disclosure. In the embodiment, a first sound-pickup device may be an earphone body of a Bluetooth earphone, a second sound-pickup device is an earphone storage case of the Bluetooth earphone, and a first terminal device may be a mobile phone or a laptop computer in communication connection with the Bluetooth earphone. A button for generating a voice signal switch instruction is provided on the earphone storage case. As illustrated in FIG. 5, an earphone storage case 100 includes a shell 10, a button 20, and a circuit board. A mounting slot 11 is provided on the outer surface of the shell 10. The button 20 is provided in the mounting slot 11 and connected to the shell 10. The circuit board is provided inside the shell 10 and electrically connected to the button 20. The circuit board is used for generating the voice signal switch instruction in response to a pressing operation on the button 20. The button 20 constitutes at least a part of the outer surface of the earphone storage case 100.

In some embodiments, at least one of the first sound-pickup device, the first terminal device, or the second sound-pickup device is provided with a sensor. The method for voice signal switching includes the following. When a signal received by the sensor satisfies a preset action condition, the voice signal switch instruction is generated.

It should be understood that in the embodiments, based on the detection function of the sensor, the possible switching intention is captured from user’s action, thereby switching between the first microphone and the second microphone is performed. Compared with the previous method where the user actively initiates switching, these embodiments provide a method for automatically initiating switching by the first sound-pickup device, the first terminal device, or the second sound-pickup device. In some embodiments, the preset action condition can be set according to the feature of the action required for the user to use the first/second sound-pickup device to collect sound. Thus the sensor can be used for detecting whether the action of using the first/second sound-pickup device to collect the sound occurs, which then may trigger the voice signal switch instruction. In other embodiments, a user switching action can be preset, so that the sensor can be used for detecting the user switching action, which then may trigger the voice signal switch instruction.

In some embodiments, the first sound-pickup device is a wearable device worn on a human ear, and the second sound-pickup device is provided with a motion sensor for detecting a motion state of the second sound-pickup device. The method for voice signal switching includes the following. When the motion state of the second sound-pickup device satisfies a preset motion condition, the voice signal switch instruction is generated. Alternatively, the first sound-pickup device is a wearable device worn on a human ear, and the second sound-pickup device is provided with a position sensor for detecting a relative position between the second sound-pickup device and the first sound-pickup device. The method includes the following. When the relative position between the second sound-pickup device and the first sound-pickup device satisfies a preset position condition, the voice signal switch instruction is generated.

In some embodiments, the first sound-pickup device is a wearable device worn on a human ear. For example, the first sound-pickup device may be the earphone body of the wireless earphone, and the second sound-pickup device is the earphone storage case in this case. Alternatively, the first sound-pickup device may be a glasses body of a pair of smart glasses, and the second sound-pickup device is a glasses case in this case. It should be understood that when the user is using the wearable device, the second sound-pickup device is usually in an idle state and placed in a clothing pocket or another position lower than the user’s mouth. When the second sound-pickup device is used for collecting the sound signal, the second sound-pickup device needs to be picked up and placed close to the user’s mouth. The second sound-pickup device needs to move in this process. In some embodiments, a motion curve of the second sound-pickup device during the process of the user picking up the second sound-pickup device and placing the second sound-pickup device close to the user’s mouth can be collected through multiple experiments, and the feature of the motion curve can be extracted. For example, the abscissa of the motion curve is time (t), and the ordinate is the height (h) of the second sound-pickup device. At time t=0, h is the height of the second sound-pickup device in the idle state. During the moving process, h increases rapidly and then gradually stabilizes at the height of the user’s mouth. Thus, when the second sound-pickup device is connected to the first sound-pickup device or the first terminal device, the motion sensor can be used for detecting the change curve of the height of the second sound-pickup device over time. When the change curve conforms to the feature obtained in the above multiple experiments, it can be considered that the second sound-pickup device is brought to the position of the user’s mouth. Accordingly, it can be determined that the user intends to use the second sound-pickup device to collect the sound signal, thereby generating the voice signal switch instruction.

In some embodiments, the first sound-pickup device is a wearable device worn on the human ear. For example, the first sound-pickup device may be the earphone body of the wireless earphone, and the second sound-pickup device is the earphone storage case in this case. Alternatively, the first sound-pickup device may be the glasses body of the pair of smart glasses, and the second sound-pickup device is the glasses case in this case. It should be understood that when the user uses the wearable device, the first sound-pickup device is worn on the human ear, while the second sound-pickup device is placed far from the human ear, such as in a pocket or held in the hand, so that the second sound-pickup device is far from the first sound-pickup device. When the user uses the second sound-pickup device to pick up the sound signal, the second sound-pickup device needs to be brought to the position close to the user’s mouth, and the second sound-pickup device is close to the first sound-pickup device in this case. In some embodiments, the position sensor of the second sound-pickup device detects the relative position between the second sound-pickup device and the first sound-pickup device. When the relative position between the two sound-pickup devices is less than a configured distance threshold, it is determined that the user intends to use the second sound-pickup device to collect the sound signal, and the voice signal switch instruction is generated.

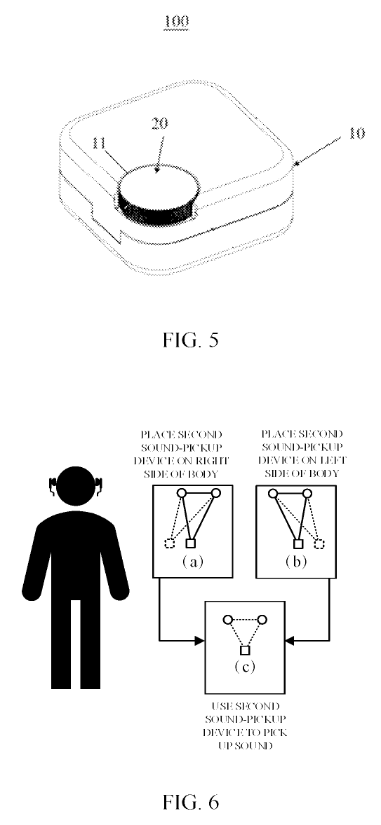

Specifically, for a scenario that the first sound-pickup device is the earphone body of the wireless earphone and the second sound-pickup device is the earphone storage case, the present disclosure discloses another working method for the position sensor. FIG. 6 is an exemplary schematic diagram illustrating a positional relationship between the earphone body and the earphone storage case in some embodiments of the present disclosure. Subfigures (a), (b), and (c) in FIG. 6 respectively illustrate the relative positional relationships among the left earphone body, the right earphone body, and the earphone storage case under different cases. In the figures, the earphone body is represented by ○ and the earphone storage case is represented by □. When the user uses the wireless earphone, the left earphone body and the right earphone body are worn on the ears. When the earphone storage case is in the idle state, as illustrated in subfigures (a) and (b) of FIG. 6, the earphone storage case is usually at one side of the user’s body. In this case, the earphone storage case is close to the earphone body at the same side but far from the earphone body at the other side. When the user intends to use the earphone storage case to collect the sound signal, the earphone storage case is brought close to the user’s mouth. As illustrated in subfigure (c) of FIG. 6, the earphone storage case, the left earphone body, and the right earphone body approximately form an isosceles triangle with the earphone storage case as the apex angle, and the distances from the earphone storage case to the earphone bodies at both sides are approximately equal.

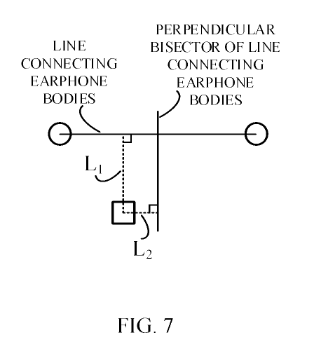

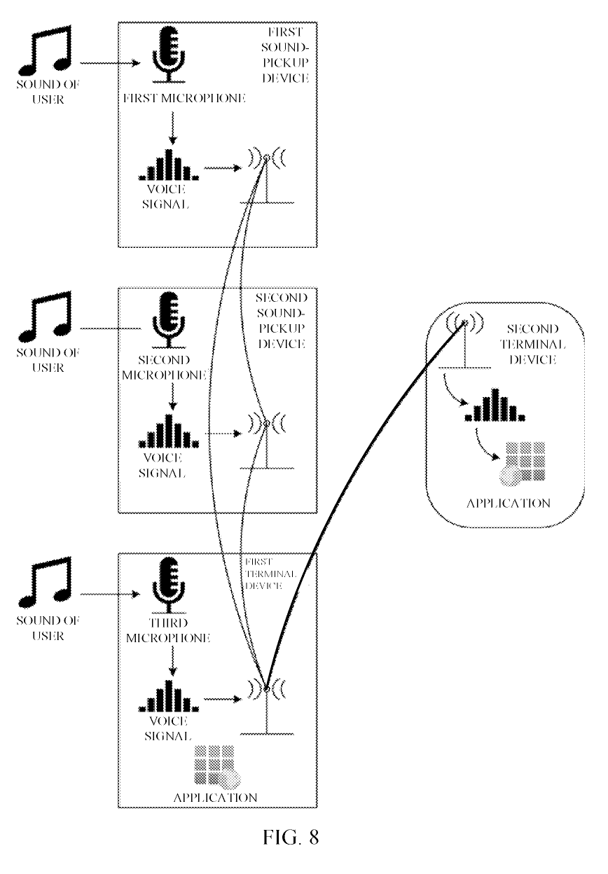

FIG. 7 is an exemplary schematic diagram illustrating a working principle of a position sensor in some embodiments of the present disclosure. In some embodiments, the position sensor is provided in an earphone storage case of a wireless earphone, and can detect the relative position among the earphone storage case and a left earphone body and a right earphone body. When the earphone storage case is on a perpendicular bisector of the line connecting the left earphone body and the right earphone body, or the distance from the earphone storage case to the perpendicular bisector of the line connecting the left earphone body and the right earphone body (i.e., L2 in FIG. 7) is less than a first set distance threshold, it is determined that the user intends to use the earphone storage case to collect the sound signal, and the voice signal switch instruction is generated. Furthermore, to improve the accuracy of identifying the intention of the user to use the earphone storage case to collect the sound signal, in other embodiments, the position sensor is provided in the earphone storage case of the wireless earphone, and can detect the relative position among the earphone storage case, the left earphone body and the right earphone body. When the distance from the earphone storage case to the perpendicular bisector of the line connecting the left earphone body and the right earphone body is less than the first set distance threshold, and the distance from the earphone storage case to the line connecting the left earphone body and the right earphone body (i.e., L1 in FIG. 7) is less than a second set distance threshold, it is determined that the user intends to use the earphone storage case to collect the sound signal, and the voice signal switch instruction is generated.

In some embodiments, the collection of the sound signal is controlled to switch between the first microphone and the second microphone as follows. Based on a specific voiceprint feature, a first voice signal is extracted from a voice signal collected by the first microphone. Based on a specific voiceprint feature, a second voice signal is extracted from the voice signal collected by the second microphone. The collection of the sound signal is controlled to switch between the first microphone and the second microphone according to signal strengths of the first voice signal and the second voice signal.

It should be understood that the voiceprint feature refers to the unique acoustic feature of each person when speaking, which includes but not limited to the vibration frequencies of the sound signal. In some embodiments, a clear sound signal of the user of the wearable device is collected, and a time-frequency transform algorithm (such as Fourier transform and wavelet transform) is used for extracting a concentrated frequency band from the sound signal, and the concentrated frequency band is used as the user’s characteristic frequency range. After the first voice signal is collected by the first microphone and the second voice signal is collected by the second microphone, a band-pass filter is used for processing the first voice signal and the second voice signal to retain a signal in the characteristic frequency domain and block a signal of other frequencies, thus obtaining the first voice signal and the second voice signal. In this way, only the sound signal of the user is retained in the first voice signal and the second voice signal, and ambient noise is filtered out. The signal strengths of the first voice signal and the second voice signal are then compared, and the microphone corresponding to the voice signal with the greater signal strength is selected to collect the sound signal, which can improve the voice input effect of the wearable device. In some embodiments, the signal strengths are compared according to the amplitudes of the first voice signal and the second voice signal. In other embodiments, the signal strengths are compared according to the powers of the first voice signal and the second voice signal.

In some embodiments, the first terminal device includes a third microphone. The method for voice signal switching includes the following. In response to receiving a working mode switch instruction, a microphone is selected to collect the sound signal according to the signal strengths of the sound signals collected by the first microphone, the second microphone, and the third microphone. The first terminal device sends the sound signal to the second terminal device.

FIG. 8 is an exemplary schematic diagram illustrating a working mode in some embodiments of the present disclosure. As illustrated in FIG. 8, each of the first terminal device, the first sound-pickup device, and the second sound-pickup device is provided with a microphone to collect a sound signal, and a communication connection can be established between any two of the three devices. In addition, a communication connection can also be established between the first terminal device and a second terminal device. It should be understood that different from the working mode illustrated in FIG. 4, in the working mode illustrated in FIG. 8, the first sound-pickup device, the second sound-pickup device, and the first terminal device can all collect the sound signal, and the voice signal is sent to the second terminal device through the communication connection between the first terminal device and the second terminal device. The working mode illustrated in FIG. 8 is applicable to a multi-person meeting scenario. In this scenario, multiple participants in meeting room A and participants in meeting room B conduct a remote meeting through the first terminal device and the second terminal device. The first sound-pickup device, the second sound-pickup device, and the first terminal device can be placed at different positions in meeting room A respectively. When each participant speaks, the sound signal can be collected according to the device with the higher signal strength of the sound signal among the first sound-pickup device, the second sound-pickup device, and the first terminal device, thereby facilitating the speech of multiple participants in meeting room A and improving the voice input effect of each participant. The selection of the microphone to collect the sound signal according to the signal strength of the sound signal has been described in detail above and will not be repeated here.

In some embodiments, in the method for voice signal switching, the first sound- pickup device is provided with a first noise reduction model for performing noise reduction on the sound signal collected by the first microphone. The second sound-pickup device is provided with a second noise reduction model for performing noise reduction on the sound signal collected by the second microphone.

As mentioned above, the noise reduction model can separate the sound of the user from ambient noise, thereby improving the quality of the digital signal. In these embodiments, by providing both the first sound-pickup device and the second sound-pickup device with noise reduction models, a voice signal of high quality can be generated regardless of whether the user collects the sound signal through the first sound-pickup device or the second sound-pickup device. In some embodiments, the ambient noise cancellation (ENC) algorithm is adopted as the noise reduction model.

In some embodiments, information of a connection state of the second sound-pickup device is received as follows. In response to the second sound-pickup device connecting with the first terminal device, the first terminal device sends the information of the connection state of the second sound-pickup device to the first sound-pickup device. Alternatively, in response to the second sound-pickup device connecting with the first sound-pickup device, the second sound-pickup device sends the information of the connection state of the second sound-pickup device to the first sound-pickup device.

It should be understood that the second sound-pickup device can be selectively connected to the first sound-pickup device or the first terminal device. After the second sound-pickup device is connected to either the first sound-pickup device or the first terminal device, the first sound-pickup device or the first terminal device can obtain the information of the connection state of the second sound-pickup device through the communication connection between the device itself and the second sound-pickup device. In these embodiments, the information of the connection state of the second sound-pickup device is sent to the first sound-pickup device, which enables the first sound-pickup device to stop the operation of the first microphone in the case that the microphone of the second sound-pickup device is used for collecting the sound signal, thereby coordinating the microphones in the first sound-pickup device and the second sound-pickup device.

Furthermore, the present disclosure discloses a voice signal switching system. The system includes a first sound-pickup device with a first microphone and a second sound-pickup device with a second microphone. The first sound-pickup device is configured to establish a connection with a first terminal device. The first microphone is configured to collect a sound signal and transmit the sound signal to the first terminal device. The system is configured to receive information of a connection state of the second sound-pickup device. When the connection state is that the second sound-pickup device is connected to the first sound-pickup device, or that the second sound-pickup device is connected to the first terminal device, the system is configured to control collection of the sound signal to switch between the first microphone and the second microphone based on a voice signal switch instruction.

Furthermore, the present disclosure discloses a wearable device. The wearable device includes a first microphone. The wearable device is configured to establish a connection with a first terminal device. The first microphone is configured to collect a sound signal and transmit the sound signal to the first terminal device. The wearable device is further configured to stop using the first microphone to collect the sound signal and to transmit the sound signal, or stop using the first microphone to transmit the sound signal to the first terminal device in response to receiving a first voice signal switch instruction. Alternatively, the wearable device is further configured to use the first microphone to collect the sound signal and transmit the sound signal to the first terminal device in response to receiving a second voice signal switch instruction.

It should be understood that the second voice signal switch instruction is used for switching collection of the sound signal to the first microphone, and the first voice signal switch instruction is used for switching the collection of the sound signal away from the first microphone. Corresponding to the foregoing embodiments, the wearable device may be a device body of a wearable device, which includes an earphone body of a wireless earphone, a watch body of a smartwatch, a glasses body of a pair of smart glasses, etc.

Furthermore, the present disclosure discloses a sound-pickup device. The sound-pickup device includes a second microphone. The sound-pickup device is configured to establish a connection with a communication device. The second microphone is configured to collect a sound signal and transmit the sound signal to the communication device. The sound-pickup device is further configured to use the second microphone to collect the sound signal and transmit the sound signal to the communication device in response to receiving a first voice signal switch instruction. Alternatively, the sound-pickup device is further configured to stop using the second microphone to collect the sound signal and to transmit the sound signal to the communication device in response to receiving a second voice signal switch instruction.

It should be understood that the first voice signal switch instruction is used for switching collection of the sound signal to the second microphone, and the second voice signal switch instruction is used for switching the collection of the sound signal away from the second microphone. Corresponding to the foregoing embodiments, the sound-pickup device may be a storage unit of a wearable device, which includes an earphone storage case of a wireless earphone, a watch case of a smartwatch, a glasses case of a pair of smart glasses, etc.

In summary, specific functions implemented by the voice signal switching system, the wearable device, and the sound-pickup device provided in the implementations of the specification can be interpreted with reference to the foregoing implementations in the specification, and can achieve the technical effects of the foregoing implementations, which will not be repeated here.

It should be noted that for the sake of brevity, the present disclosure describes some methods and their embodiments as a series of actions and combinations thereof, but those skilled in the art can understand that the solution of the present disclosure is not limited by the order of the described actions. Therefore, based on the disclosure or teaching of the present disclosure, those skilled in the art can understand that some of the steps may be performed in other orders or simultaneously. Furthermore, those skilled in the art can understand that the embodiments described in the present disclosure may be regarded as optional embodiments, that is, the actions or modules involved therein are not necessarily required for the implementation of a certain or some solutions of the present disclosure. In addition, according to different solutions, the descriptions of some embodiments in the present disclosure each have their own focus. In view of this, those skilled in the art can understand that for the parts not described in detail in a certain embodiment of the present disclosure, reference may also be made to the relevant descriptions of other embodiments.

What is claimed is:

1. A method for voice signal switching, comprising a first sound-pickup device with a first microphone and a second sound-pickup device with a second microphone, wherein
the first sound-pickup device is used for connecting with a first terminal device; and
the first microphone is used for:
collecting a sound signal; and
transmitting the sound signal to the first terminal device; and
the method further comprises:
receiving information of a connection state of the second sound-pickup device; and
when the connection state is that the second sound-pickup device is connected to the first sound-pickup device, or that the second sound-pickup device is connected to the first terminal device,
receiving a voice signal switch instruction; and
controlling collection of the sound signal to switch from the first microphone to the second microphone.

2. The method of claim 1, wherein at least one of the first sound-pickup device, the first terminal device, and the second sound-pickup device is provided with a button, and the method comprises:
when the button triggers the voice signal switch instruction, controlling the collection of the sound signal to switch between the first microphone and the second microphone.

3. The method of claim 2, wherein the first sound-pickup device is an earphone, the second sound-pickup device is an earphone storage case corresponding to the earphone, and the button is provided on the earphone storage case.

4. The method of claim 1, wherein at least one of the first sound-pickup device, the first terminal device, and the second sound-pickup device is provided with a sensor, and the method comprises:
generating the voice signal switch instruction when a signal received by the sensor satisfies a preset operation condition.

5. The method of claim 4, wherein
the first sound-pickup device is a wearable device worn on a human ear;
the second sound-pickup device is provided with a motion sensor for detecting a motion state of the second sound-pickup device; and
the method comprises:
generating the voice signal switch instruction when the motion state of the second sound-pickup device satisfies a preset action condition;
or
the first sound-pickup device is a wearable device worn on the human ear;
the second sound-pickup device is provided with a position sensor for detecting a relative position between the second sound-pickup device and the first sound-pickup device; and
the method comprises:
generating the voice signal switch instruction when the relative position between the second sound-pickup device and the first sound-pickup device satisfies a preset position condition.

6. The method of claim 1, wherein controlling the collection of the sound signal to switch between the first microphone and the second microphone comprises:
extracting, based on a specific voiceprint feature, a first voice signal from a voice signal collected by the first microphone;
extracting, based on the specific voiceprint feature, a second voice signal from a voice signal collected by the second microphone; and
controlling the collection of the sound signal to switch between the first microphone and the second microphone based on signal strengths of the first voice signal and the second voice signal.

7. The method of claim 1, wherein the first terminal device comprises a third microphone, and the method comprises:
in response to receiving a working mode switch instruction, selecting a microphone to collect a sound signal based on signal strengths of sound signals collected by the first microphone, the second microphone, and the third microphone; and
sending, by the first terminal device, the sound signal to a second terminal device.

8. The method of claim 1, wherein
the first sound-pickup device is provided with a first noise reduction model for performing noise reduction on a sound signal collected by the first microphone; and
the second sound-pickup device is provided with a second noise reduction model for performing noise reduction on a sound signal collected by the second microphone.

9. The method of claim 1, wherein receiving the information of the connection state of the second sound-pickup device comprises:
in response to the second sound-pickup device connecting with the first terminal device, sending, by the first terminal device, the information of the connection state of the second sound-pickup device to the first sound-pickup device; or
in response to the second sound-pickup device connecting with the first sound-pickup device, sending, by the second sound-pickup device, the information of the connection state of the second sound-pickup device to the first sound-pickup device.

10. A voice signal switching system, comprising a first sound-pickup device with a first microphone and a second sound-pickup device with a second microphone, wherein
the first sound-pickup device is configured to connect with a first terminal device;
the first microphone is configured to:
collect a sound signal; and
transmit the sound signal to the first terminal device; and
the system is configured to:
receive information of a connection state of the second sound-pickup device; and
when the connection state is that the second sound-pickup device is connected to the first sound-pickup device, or that the second sound-pickup device is connected to the first terminal device,
control collection of the sound signal to switch between the first microphone and the second microphone based on a voice signal switch instruction.

11. A sound-pickup device, comprising a second microphone, wherein
the sound-pickup device is configured to connect with a communication device;
the second microphone is configured to:
collect a sound signal; and
transmit the sound signal to the communication device; and
the sound-pickup device is further configured to:
in response to receiving a first voice signal switch instruction,
use the second microphone to collect the sound signal; and
transmit the sound signal to the communication device; and
in response to receiving a second voice signal switch instruction, stop using the second microphone to collect the sound signal and to transmit the sound signal to the communication device.
